(19) United States
(12) Patent Application Publication
(10) Pub. No.: US 2011/0105647 A1
(43) Pub. Date: May 5, 2011

(54) Countertop Coating

(75) Inventors: Kymarie Kuster-Kosmoski, Milwaukee, WI (US); Randall Zempel, Racine, WI (US); Herman Bacchus, Antioch, IL (US)

(73) Assignee: Rust-Oleum Corporation, Vernon Hills, IL (US)

(21) Appl. No.: 12/915,622

(22) Filed: Oct. 29, 2010

Related U.S. Application Data
(60) Provisional application No. 61/280,149, filed on Oct. 30, 2009.

(51) Int. Cl. C09D 163/00

(52) U.S. Cl. 523/435

(57) ABSTRACT

Two component coatings having a viscosity range of 6 to 9 wet mils of sag consisting of a base component and an activator component. The base component comprises an epoxy siloxane resin and an alkyl quaternary ammonium clay rheology agent, and the activator component is an amino silane.

### BACKGROUND OF INVENTION

This invention relates to paint compositions useful for protecting faux finish and decorative kitchen countertop coatings. More particularly, the present invention relates to paint compositions which are suitable for brush or roller application and which contain an epoxy siloxane polymer which can be applied to both vertical and horizontal surfaces at wet film thicknesses of up to eight mils.

The kitchen can be viewed as the heart of the home—a place where family and friends congregate—an expression of a homeowner's style and personality. From a financial perspective, it's also recognized that a stylish, well functioning kitchen significantly contributes to a home's overall value. With the high cost of new granite and marble countertops, many homeowners who remodel their kitchens opt to keep their existing countertops. Therefore it would be desirable to have a coating system that could be used to coat a kitchen counter and provide the look of granite and be affordable to most home owners. To be practical as a countertop coating, the coating system has to be durable and able to withstand stains caused from food, beverages, water and cleaning solutions.

There are faux coatings systems that can provide the look of granite, marble or other stone surfaces. These coatings systems employ a base coat for color, additives such as chips or color blends to provide the granite or marble look and a protective top coat. The top coat protects the base coat and additives from wearing, fading, scratching and staining. It also secures the chips dispersed into the base coat and provides the desired gloss of the coating system.

There are existing clear coatings which are used as top coats for faux and decorative coatings. These clear top coats can be distinguished from one another by the type of resin used in the coating. The three most common resins used in clear top coats are acrylic, epoxy and polyurethane. Coatings based on all three of these resins were considered as top coats for faux countertop coatings systems.

Acrylic-based clear topcoats are commonly used to protect faux finishes. They are water-based and easy to apply. They have both indoor and outdoor durability and gloss retention. But, they lack the durability needed for use on kitchen countertops. Kitchen countertops are subjected to foods, beverages and cleaning solutions which would stain and tend to deteriorate clear acrylic coatings.

Epoxy-based clear topcoats have excellent durability and resistance to chemicals, such as those found in foods, beverages and cleaning solutions. Commercially available epoxy coatings consist of both water-based and solvent-based coatings. Water-based epoxy clear coatings would be preferred for home use in view of the presence of strong solvents in the solvent-based epoxies. But, water-based, like solvent-based epoxies, tend to yellow when exposed to sunlight or other sources of ultraviolet light. In a kitchen which is exposed to significant sunlight, the clear topcoat will begin to turn yellow in appearance in a matter of time.

Polyurethane coatings on the other hand do not yellow when exposed to sunlight. In fact, polyurethane coatings are used to topcoat epoxy coatings used outdoors, not only to afford additional protection, but to prevent the epoxy base coat from changing color or gloss. Like epoxy coatings, polyurethane coatings consist of both water-based and solvent-based coatings. Like epoxy coatings, the water-based polyurethane coatings would be preferred for indoor use in view of the strong solvents used in solvent-based polyurethane coatings. Although water-based polyurethane coatings are very durable they are applied at thin wet film thicknesses of 2 to 3 mils wet. Two to three coats of a water-based polyurethane coating would be needed to afford the same protection of a heavy duty epoxy coating. In addition, it was found that polyurethane coatings tested for kitchen use tended to haze from standing water, an exposure which is expected for kitchen countertops.

An ideal topcoat for a kitchen countertop coating system would be a water-based epoxy based coating which would not fade or change color and which can be applied at wet film thickness greater than polyurethane coatings. Coatings based on epoxy siloxane resins not only have the durability of epoxy coatings, they are not affected by exposure to sunlight. In fact, it was found that they were more durable and had better stain resistance than pure epoxy coatings.

In addition to durability, color or clearness retention, and stain resistance, there are other qualities desired for protective coatings which are applied over faux finish base coats such as countertop coatings.

One such desirable quality is that in addition to being “brushable” they should also be “rollable.” In other words, a user should be able to apply the coating by roller as well as by brush. This allows the user to roll on the coatings over large horizontal and vertical surfaces as well as brush on the coating in less accessible areas such as corners and small surface areas. The coatings of this invention can be applied by brush or roller.

A second desired quality of the coating is that it must be thick enough to cover the chips and yet be able to penetrate around the chips to further secure them to the surface and provide a smooth even surface. Most of the chips added to the base coat to give the coating a faux finish remain on the surface of the dried base coat. The coatings of this invention are thick enough when applied to cover all the chips on the surface of the base coat in one coat and also penetrate around the chips to form a smooth surface.

The coating must remain “open”, that is, it must remain wet for a sufficient time during application to allow the coating to form a film over all the chips and provide a uniform surface. The coatings of this invention remain open for sufficient time to allow the user to coat a fifty square foot surface in a uniform thickness.

Since most kitchen counters have vertical areas, such as back drops, as well as the horizontal surface of the counter, the coating must be able to be applied to both vertical and horizontal surfaces. Through the use of unique rheology control additives the coatings of this invention can be applied in wet thicknesses of up eight mils on both vertical and'horizontal surfaces. The ability for the coatings of this invention to be applied both vertically and horizontally at wet film thickness of up to eight mils allows the coating to be applied in one coat for the protection needed for countertops. Two to three coats of a polyurethane coating would have to be used to get the same protection as one coat of the coatings of this invention.

### SUMMARY OF INVENTION

Coatings of the present invention comprise an epoxy siloxane resin and a rheology agent which provides significantly improved sag resistance and still maintains good flow. The coatings are two component systems wherein a base coat is activated by the addition of an activator at the time of use. The epoxy siloxane resin provides a coating with excellent flow properties and a large open time to cure. The rheology agent is an alkyl quaternary ammonium clay which improves sag resistance, thereby allowing the vertical application of the coating as well as the application of the coating to horizontal surfaces. The coatings can be applied at a wet film thickness of up to eight mils, thereby providing a protective coating film sufficient for use on a kitchen counter with just one application. The activator component is an amino silane compound, including 3-aminopropyltriethoxysilane or 3-aminopropyltrimethoxysilane and blends of these two chemicals.

### DETAILED DESCRIPTION OF THE INVENTION

Coatings based on 1) two component epoxy, 2) decoupage, 3) polyurea, 4) two component polyurethane and 5) epoxy siloxane resin systems were tested for use as protective top coats for use on kitchen countertop coatings. The epoxy siloxane based technology looked promising because of its non-yellowing and non-isocyanate chemistry. Coatings based on this technology also had excellent flow properties and large open time to cure. Coatings using Silikopon EF, a high solids epoxy siloxane resin, have the desirable qualities for a protective top coat for use in countertop coating systems, but they, like other epoxy siloxane coatings, lacked sag resistance and were not suitable for application to vertical surfaces. In addition, the manufacturer of Silikopon EF, Evonik Industries, published in its technical literature that the maximum thickness for coatings using Silikopon EF resin should not be more than four mils. The desired application thickness of a protective top coat for use on countertops is between six to eight mils. This desired film thickness would provide adequate protection with one coat.

Epoxy siloxane coatings, including coatings made with Silikopon EF resin, had very good flow and were easily applied to horizontal surfaces, but they lacked sag resistance sufficient to be applied to vertical surfaces at any appreciable film thickness. It has been found that the ideal sag resistance for these countertop coatings is in the range of 6 to 9 in order to get wet film thicknesses of 6 to 8 mils. The manufacturer of Silikopon EF recommended several rheology agents to increase the sag of the coating, but none of the recommended rheology agents provided sag resistance above three. Several other rheology agents were tested in order to find a combination of resin and rheology agent to form a coating which had sag greater than 3 and still maintain adequate flow to cover the chips disbursed in the base coat and form a smooth finish. The addition of several different rheology agents did not provide coatings with sufficient sag resistance, except for two: Garamite 1958, an alkyl quaternary ammonium clay supplied commercially by SCP; and Byk 410, a modified urea thickener supplied commercially by Byk Chemie. Although both rheology agents provided sufficient sag resistance to allow vertical application of the coating, only coatings Garamite 1958 brushed smoothly over the chipped surface on the horizontal and vertical surfaces of the faux finish countertop.

The test method used to measure sag resistance was the ASTM D-440-84 Leneta sag test. Coatings with sag resistance of less than 6 did not provide sufficient vertical film build to provide one-coat protection for countertops. Coatings with sag resistance greater than 9 tend to have compromised flow. This compromised flow property results in incomplete “wetting” of the decorative chips in the base coat, leading to incompletely covered chips and irregular surface. Table 1 lists test results for several of the rheology agents tested with the epoxy siloxane resin based coating.

TABLE 1
Rheology control additives

| Additive | Type | Supplier | % Level | Sag |
|---|---|---|---|---|
| Garamite 1958 | Alkyl Quaternary | SCP | 1-6% | 6 |
| | Ammonium Clay | | | |
| Crayvallac | Polyamide wax | Cray | 6% | <3 |
| Super | | | | |
| Cabosil | Untreated fumed silica | Cabot | 3% | <3 |
| Aerosil 972 | Treated fumed silica | Grace Davidson | 3% | <3 |
| Bentone SD2 | organic derivative of a | Elementis | 2% | <3 |
| | bentonite clay | | | |
| Byk 410 | Modified urea thickener | Byk Chemie | 1% | >12 |
| Tixogel MP250 | Quaternary ammonium | SCP | 3% | <3 |
| | bentonite | | | |
| Ircogel 941 | Calcium sulfonate | Lubrizol | 3% | <3 |

Further testing of different epoxy siloxane coatings identified defoamer and flow additive combinations. The defoamer prevents foaming of the Silikopon EF base during the process of dispersing the Garamite 1958 during the manufacture of the base coat and during application of the coating. The flow additives allow the flow-out of the craters caused by the defoamer during application of the coating.

The gloss of the epoxy siloxane coating can be adjusted by varying the ratio of base coat to the activator. High gloss coatings are formulated at a weight ratio of 4.5 parts base to one part activator. The amount of Garamite 1958 included in the formula of the base for high gloss coatings ranges from 0.2% to 0.9% by weight, with the preferred amount of 0.5%. Low gloss coatings are formulated at a weight ratio of 6.5 parts base to one part activator. The amount of Garamite 1958 included in the formula of the base for semi-gloss coatings ranges from 1.0% to 1.4% by weight, with the preferred amount of close to 1.0%. Also, screening for a lower gloss showed interesting results using large polycarbonate, polypropylene and/or polyamide wax (200 mesh=75 microns) for flattening (lowering gloss) while maintaining solids close to 100%.

To further evaluate the coverage and vertical sag resistance and proper flow over vertical and horizontal surfaces, an experiment was done to compare a 100% solids epoxy versus an epoxy siloxane topcoat with Garamite 1958. The epoxy siloxane resin used was Silikopon EF from Evonik Industries. Results showed the epoxy siloxane coating to have almost the same weight loss between the vertical and horizontal panel while the epoxy had a 13% weight loss for the vertical panel. Sec Table 2 below. The vertical film of the epoxy siloxane coating had basically the same film build as did the horizontal surface film, whereas the vertical film of the 100% solids epoxy coating had 13% less film build as the horizontal surface film. The appearance was also significantly different, whereas the epoxy siloxane coating coats and covers the chipped surface, the epoxy fills the chips leaving chips lifted and exposed. The Garamite 1958 appears to give a rheology profile of the coating to allow the coating to be applied by brush and roll onto a surface at high film thickness (approximately 6-8 mils) and to hang onto to the chips while still flowing out enough to give a smooth surface on both horizontal and vertical surfaces.

TABLE 2

| | Silikopon EF | 100% solids |
|---|---|---|
| | Topcoat | Epoxy |
| Vertical chipped | 0.1% | 13% |
| substrate-% loss | | |
| Horizontal chipped | 0% | 0% |
| substrate-% loss | | |

The coatings of this invention are two-component coatings. They consist of a base and an activator. The base and activator are combined just prior to application of the coating. The activators used in coatings of this invention are amino silanes. Two preferred amino silanes are 3-aminopropyltriethoxysilane and 3-aminopropyltrimethoxysilane, which are commercially available from Evonik Industries under the name Dynasylan AMEO and AMMO. The following is an example of a formula and sequence for ingredient processing for the base coat of the present invention:

### Example 1

### Gloss Clearcoat Base

| | | | |
|---|---|---|---|
| Description | Amount (lb) | Amount_gal._ | Weight_% |

Coating is a high gloss clear, make sure tank is clean.

| | | | |
|---|---|---|---|
| Silicone Epoxy Silikopon EF | 470 | 50 | 50.099 |
| Tego Airex 940 Defoamer | 8 | 1.067 | 0.8527 |
| GARAMITE 1958 | 19 | 1.426 | 2.053 |

HSD with Cowles Blade to a 6 Hegman
LETDOWN: Add the following in order of addition

| | | | |
|---|---|---|---|
| Silicone Epoxy Silikopon EF | 383.943 | 40.845 | 40.9259 |
| VanDeMark PTSI H2O | | | |
| Scavenger | 2.5 | 0.233 | 0.2665 |
| Ciba Tinuvin 292 HALS | 20 | 2.427 | 2.1319 |
| Add Tego Flow 370 | 10 | 1.042 | 1.0659 |
| Micropowders Polyfluo 190 | | | |
| PTFE/PE Wax | 20 | 2.424 | 2.1319 |

Mix container of Polyphase 2085 before adding

| | | | |
|---|---|---|---|
| Troy Polyphase 2085 | 4.7 | 0.537 | 0.501 |

Let mix under medium
agitation for 15 minutes

| | | | |
|---|---|---|---|
| TOTAL= | 938.143 lb | 100.00 GL | 100.0% |

Example 1 is an example of a clear base coat which is combined with an amino silane activator to produce a clear gloss coating suitable for application over faux coatings or as a protective coating over any other surface. In applications where an opaque protective coating is desired, pigments of colorants can be added to the base coat. The resulting opaque coatings can be applied directly to countertops or any other surfaces to provide a decorative as well as a protective surface.

What is claimed is:

1. A two component coating having a viscosity range of 6 to 9 consisting of a base component and an activator component wherein the base component comprises: a) an epoxy siloxane resin and b) a rheology agent; and the activator component is an amino silane.

2. The coating composition cited in claim 1 wherein the epoxy siloxane resin is Silikopon EF, an epoxy siloxane resin supplied commercially by Evonik Industries, and the rheology agent is an alkyl quaternary ammonium clay.

3. The coating composition cited in claim 1 wherein the epoxy siloxane resin is Silikopon EF and the rheology agent is Garamite 1958, an alkyl quaternary ammonium clay supplied commercially by SCP.

4. The coating composition cited in claim 1 wherein the amino silane activator component is 3-aminopropyltriethoxysilane or 3-aminopropyltrimehtoxysilane or a blend of the two.
